(19) United States
(12) Patent Application Publication
(10) Pub. No.: US 2008/0079757 A1
(43) Pub. Date: Apr. 3, 2008

(54) DISPLAY RESOLUTION MATCHING OR SCALING FOR REMOTELY COUPLED SYSTEMS

(76) Inventor: Roland M. HOCHMUTH, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/537,435

(22) Filed: Sep. 29, 2006

(51) Int. Cl. G09G 5/02

(52) U.S. Cl. 345/698

(57) ABSTRACT

A method comprises receiving, by a first system, from a second system a display resolution of the second system. The first and second systems are remotely coupled to one another via a network. The method further comprises, either setting, by the first system, the display resolution of the first system to match the received display resolution of the second system or scaling, by the first system, an image to account for any difference between the display resolutions or display window sizes of the first and second systems.

### BACKGROUND

Some electronic systems permit a user of one computer to view on his or her display images (graphics and text) that are generated on another computer remotely located from the user's computer. In some such “remote visualization” systems, the remote computer, which generates the graphics data, transmits uncompressed images to the user's computer that cause the user's computer to copy or move pixel data around on the user's display to replicate the images on the remote computer where the images originated. The display attached to the user's computer may be configured to a resolution that may or may not match that of the remote computer. To the extent that the resolutions do not match, information that is generated by the remote computer and intended to be shown on the user's computer may not be correctly displayed.

### BRIEF DESCRIPTION OF THE DRAWINGS

For a detailed description of exemplary embodiments of the invention, reference will now be made to the accompanying drawings in which.

FIG. 1 shows a system in accordance with various embodiments comprising a sending system and a receiving system;

FIG. 2 shows an embodiment exemplary of a sending or a receiving system;

FIG. 3 illustrates a method by which the receiving system modifies its resolution to match the resolution of the sending system in accordance with embodiments;

FIG. 4 illustrates another method by which the receiving system modifies its resolution to match the resolution of the sending system in accordance with embodiments;

FIG. 5 illustrates a method by which the sending system modifies its resolution to match the resolution of the receiving system in accordance with embodiments;

FIG. 6 illustrates another method by which the sending system modifies its resolution to match the resolution of the receiving system in accordance with embodiments;

FIG. 7 illustrates a method by which the receiving system scales images from the sending system in accordance with embodiments;

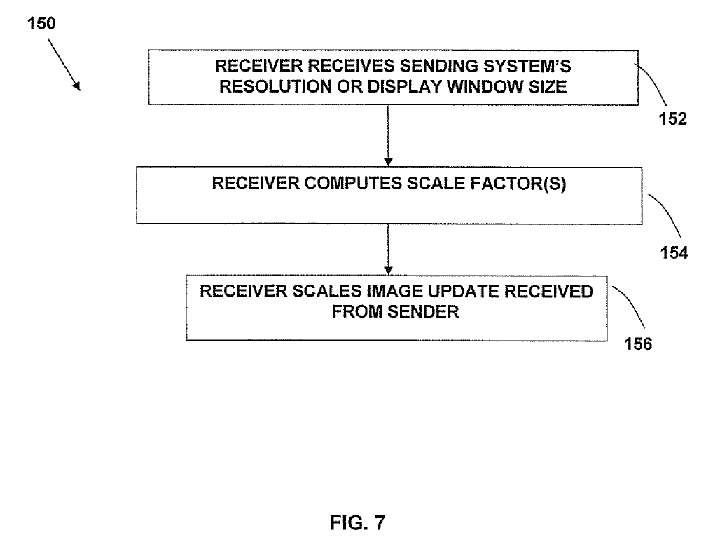

FIG. 8 illustrates a method by which the sending system scales images in accordance with embodiments;

FIG. 9 illustrates a method by which either the sending system or the receiving system scales images depending on a comparison of the resolutions of both systems in accordance with embodiments; and

FIG. 10 illustrates another method by which either the sending system or the receiving system scales images depending on a comparison of the resolutions of both systems in accordance with embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

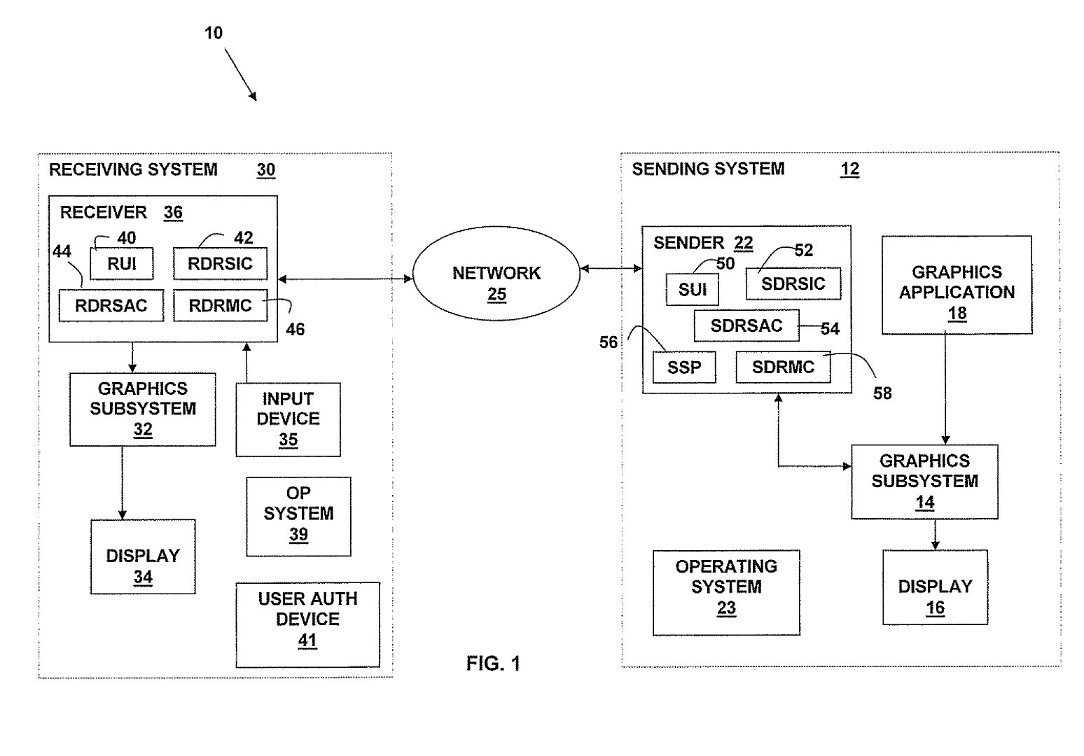

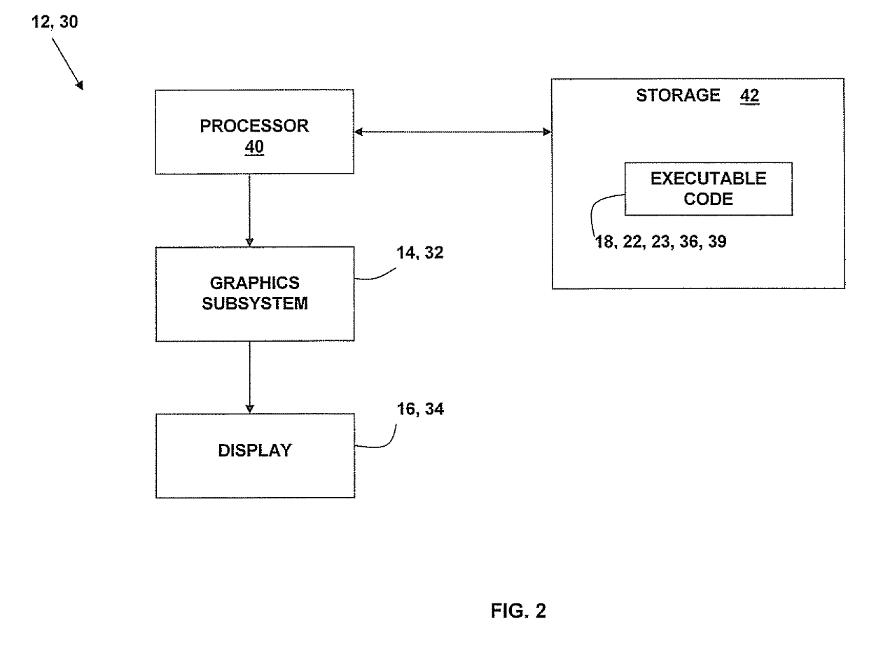

FIG. 1 shows an embodiment of a system 10 that comprises a sending system 12 and a receiving system 30 in communication with each other by way of a network 25. The systems are remotely coupled to one another via the network. Either system can be considered to be a “remote” system (relative to the other system) and either system can be considered to be a “local” system (relative to the other system). Network 25 may comprise the Internet or other form of communication network. As shown, the sending system 12 comprises a graphics subsystem 14, a display 16, a graphics application 18, a sender 22 and an operating system 23. The graphics application 18 and sender 22 comprise executable code. The receiving system 30 comprises a graphics subsystem 32, a display 34, a receiver 36, and a operating system 39. The receiver 36 and operating system 39 in the receiving system comprise executable code. Referring briefly to FIG. 2 in conjunction with FIG. 1, each of the sending system 12 and receiving system 30 comprises a processor 40, storage 42, and, as noted above, a graphics subsystem 14, 32 and a display 16, 34. Each executable code (i.e., the graphics application 18, the sender 22, the operating systems 23 and 39, and the receiver 36) in the illustrated embodiment are executed by the respective processor 40 in that system and are stored in storage 42. Storage 42 may comprise volatile storage (e.g., random access memory), non-volatile storage (e.g., hard disk drive) or a combination thereof. Each of the graphics subsystems 14 and 32 may comprise additional executable code such as application programming interfaces (APIs), graphics drivers, one or more hardware components such a graphics adapter, etc. Each graphics subsystem also includes at least one frame buffer into which pixel color values are temporarily stored to render pixels on the associated display.

In some embodiments, the sending system 12 has a display 16 coupled thereto, but in other embodiments, the sending system's display 16 is not included. The receiving system 30 may include an input device 35, such as a keyboard or mouse, which permits a user of the receiving system to effectively interact with the graphics application 18 as if the graphics application were being executed on the receiving system 30.

Referring to FIG. 1, sending system 12 executes a graphics application 18 that causes images (e.g., text, lines, fills) to be shown by the graphics subsystem 14 on the display 16. The graphics application 18 comprises any one or more of a plurality of executable programs that use a graphics API. The APIs used by the graphics application are implemented by the graphics subsystem 14. The graphics application 18 causes images to be shown on display 16 by providing graphics commands to the graphics subsystem 14 which creates and stores images in a frame buffer in the graphics subsystem 14. The sender 22 reads the images from the graphics subsystem's frame buffer and, in at least some embodiments, compresses the images for subsequent transmission to the receiving system 30. Via network 25, the sending system 12 sends the compressed images to the receiving system 30. The receiving system 30 receives the compressed images from the sending system, decompresses the images, and shows the decompressed images on display 34. The process is repetitive as the sending system continues to render new or updated images in its own graphics subsystem 14.

Referring still to FIG. 1, the sender 22 comprises a Sender User Interface (SUI) 50, a Sender Display Re-Size Component (SDRSIC) 52, a Sender Display Re-Sample Component (SDRSAC) 54, a Sender Security Policy (SSP) component 56, and a Sender Display Resolution Modification Component (SDRMC) 58. The receiver 36 comprises a Receiver User Interface (RUI) 50, a Receiver Display Re-SIze Component (RDRSIC) 42, a Receiver Display Re-SAmple Component (RDRSAC) 44, and a Receiver Display Resolution Modification Component (RDRMC) 46. In accordance with embodiments, any or all of the components of the sender 22 and receiver 36 are implemented in software, hardware or a combination of hardware and software.

In at least some embodiments, the graphics subsystem 14 of the sending system 12 can be programmed to any of multiple display resolution settings. Similarly, the graphics subsystem 32 of the receiving system 30 also can be programmed to any of multiple display resolution settings. An example of a display resolution is 1280×1024 meaning that the display is rendered with 1280 pixels across (horizontal) and 1024 pixels down (vertical). Modifying the display resolution is generally a function performed by the graphics subsystem of each of the systems 12 and 30, although other aspects of the systems 12, 30 (e.g., the operating systems 23, 39) can modify the resolution.

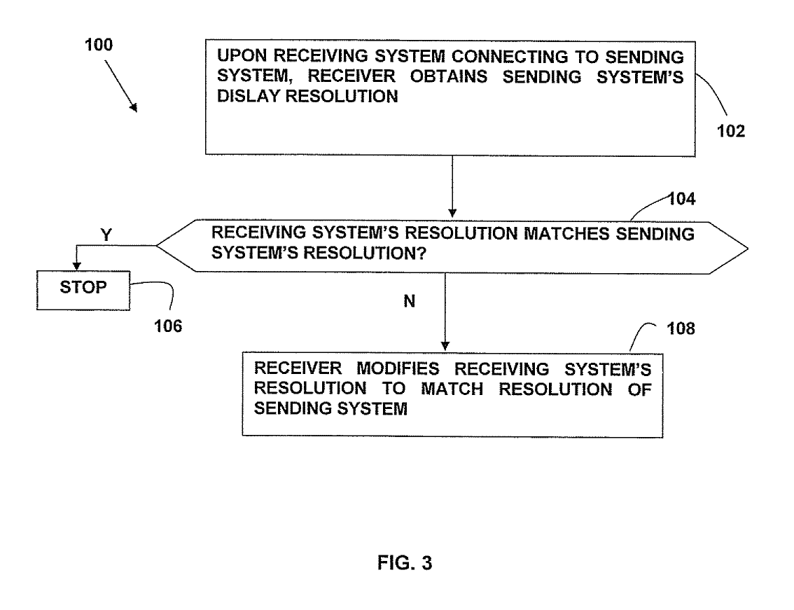

Various embodiments provide the ability to match the sending system's resolution to the receiving system's resolution. In one embodiment, the receiving system's display resolution is modified to match the resolution of the sending system 12. In another embodiment, the sending system's display resolution is modified to match that of the receiving system. In yet another embodiment, the display resolutions of both the receiving and sending systems 30, 12 are modified to match yet another display resolution. These three embodiments are explained below with regard to FIGS. 3-6. In other embodiments, the images to be displayed on the receiving system's display 34 are scaled to account for mismatches in the resolutions of the sending and receiving systems. Such embodiments comprise the receiver 36 scaling the images received from the sending system, the sender 22 scaling the images before sending the images to the receiver 36, and automatically scaling the images on the receiver or sender depending on the relative resolutions of the sending and receiving systems 12, 30. In some embodiments, the RUI 40 permits a user of the receiving system 30 to specify which of these embodiments is to be performed. In at least some embodiments, the RUI 40 provides the user with a plurality of choices on display 34. Such choices comprise:
Modify the receiving system's resolution to match the sending system's resolution
Modify the sending system's resolution to match the receiving system's resolution
Modify both the receiving and sending system's resolution
Scale the image by the receiver to match the sender's resolution
Scale the image by the sender to match the receiver's resolution
Auto-scale the images by the receiver or sender

### In accordance with some embodiments, the user selects one of these choices and the system 100 reacts, as further explained below, according to the selected choice.

FIG. 3 shows an illustrative method 100 in which the resolution of the receiving system 30 is modified to match the resolution of the sending system 12. At 102, the receiving system 30 connects to the sending system 12. This action can be performed by the receiver 36 establishing communication with the sender 22 upon, for example, a user of the receiving system 30 initially invoking the receiver 36. Upon the receiving system 30 connecting to the sending system 12, the receiver 36 obtains the display resolution currently set for the sending system 12. This action is performed by the sending system 12 automatically sending its display resolution to the receiver 36, following connection of the two systems, or upon being prompted by the receiver 36 for the sending system's resolution.

At 104, the receiver 36 determines whether the resolution of the sending system 12 matches that of the receiving system 30. If the two resolutions match, then no further action need be taken and the method terminates at 106. On the other hand, if the display resolutions of the sending and receiving systems 12, 30 do not match, then at 108, the receiver 36 causes the receiving system's display resolution to be modified to match the resolution of the sending system 12. In at least some embodiments, the RDRMC 46 modifies the receiving system's display resolution.

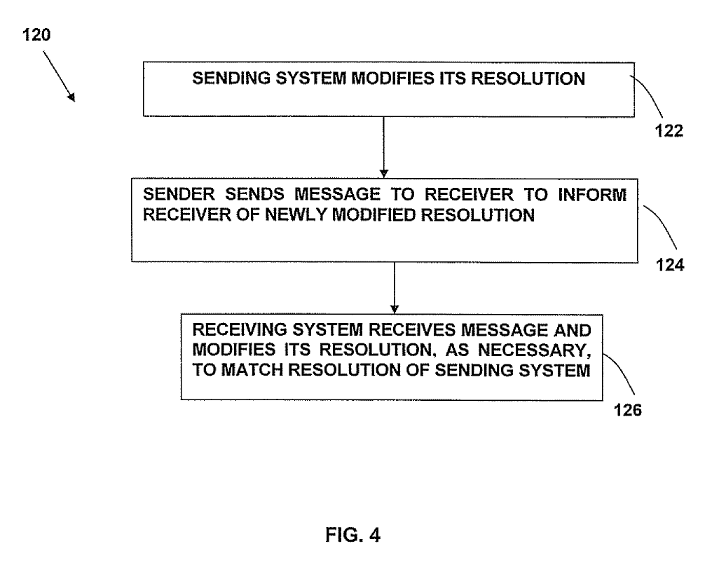

The illustrative embodiment of FIG. 3 ensures that the display resolutions of the receiving and sending systems match upon the systems' initial connection to one another. However, it is possible that a user of the sending system 12 modifies via, for example, the operating system 23, the display resolution of the sending system. At that point, the display resolutions of the sending and receiving systems would likely no longer match. FIG. 4 illustrates a method 120 in which the receiving system 30 modifies its display resolution to match a recent change in display resolution of the sending system 12. At 122, the sending system modifies its resolution. In some embodiments, the SDRMC 58 is invoked to perform this resolution modification. The modification to the sending system's resolution may result, as noted above, from a user of the sending system modifying the display resolution of the sending system. At 124, the sender 22 (specifically, the SDRMC 58) sends a message to the receiver 36 to inform the receiver of the recent modification to the sending system's display resolution. At 126, the receiver 36 receives the message from the SDRMC 58 and invokes the RDRSIC 42 which causes the display resolution of the receiving system 30 to be modified to match that of the sending system 12.

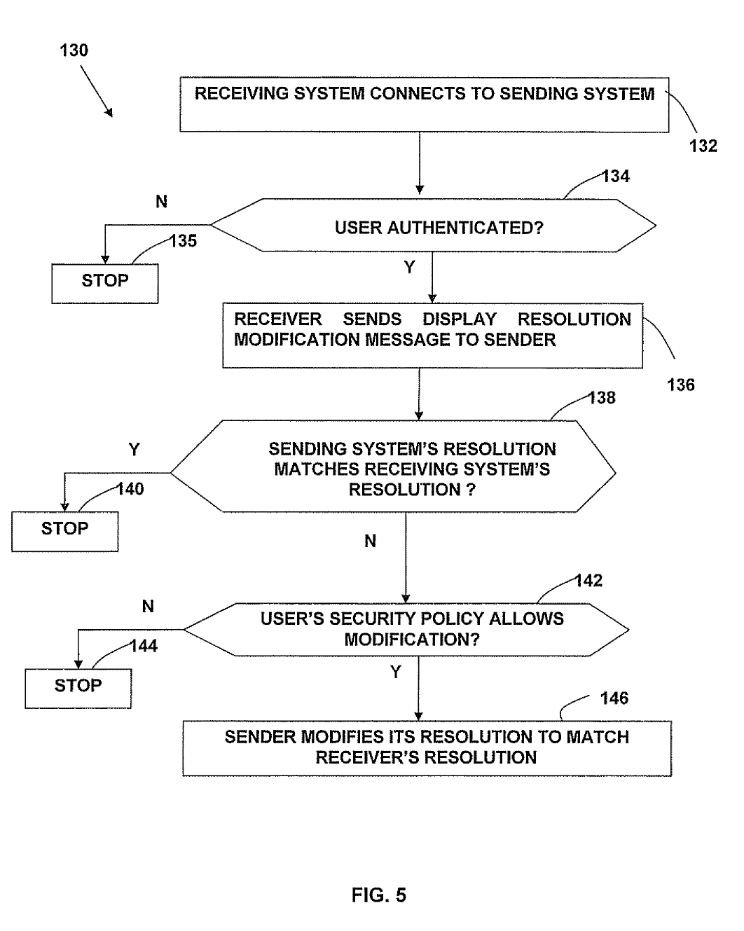

FIG. 5 illustrates a method 130 by which the sending system 12 modifies its display resolution to match that of the receiving system 30. At 132, the receiving system 30 connects to the sending system 12, an action that can be performed, for example, by the receiver 36 establishing communication with the sender 22. At 134 and in accordance with some embodiments, the user of the receiving system 30 is authenticated via user authentication device 41. User authentication can be performed in accordance with any suitable technique using, for example, a user authentication device 41 (FIG. 1) such as a keyboard to enter a password or a biometrics sensor (e.g., fingerprint or retinal scanner). Authenticating the user comprises, for example, entry of a password, fingerprint scan, retinal scan, etc. The process of authenticating the user can be performed at any time such as upon the receiver 36 establishing communication with the sender 22. In at least one embodiment, the receiver 36 attempts to authenticate the user upon invocation of the receiver. Further, associated with each authenticated user is a security policy that specifies whether that user is permitted to request and/or cause the resolution of the sending system to be modified. The SUI 50 is used to permit a user (e.g., an administrator) of the sending system 12 to specify an SSP 56 to allow or deny specific users or groups of users receiving systems 30 to modify the display resolution of the sending system 12. If the user is not successfully authenticated, then the process terminates at 135 and the sending system's resolution is not modified. If, however, the user is successfully authenticated, at 136 the receiver 36 sends a display resolution modification message to the sender 22. This display resolution modification message informs the sender 22 as to the current resolution of the receiving system 30 and requests the sending system to modify or adjust its display resolution to match. Not permitting the sending system to modify its display resolution unless the user of the receiving system is authenticated helps to control changing the sending system's display resolution, particularly if someone is directly interacting with and using the sending system.

The sender 22 receives the display resolution modification message from the receiver 36 and determines whether the sending system's display resolution matches the resolution of the receiving system (decision 138). If the resolution of the sending system already matches that of the receiving system, the process terminates at 140 and no further action is required. If, however, the resolution of the sending system 12 does not match that of the receiving system 30, at 142 the sender 22 determines whether the security policy for the user permits the user to have the resolution of the sending system modified. If the user's security policy does not permit such a modification, the process terminates at 144 and the sending system's resolution is not modified. If the security policy does permit such a modification, at 146 the sender's SDRSIC 52 causes the sending system's display resolution to be modified to match the resolution of the receiving system 30.

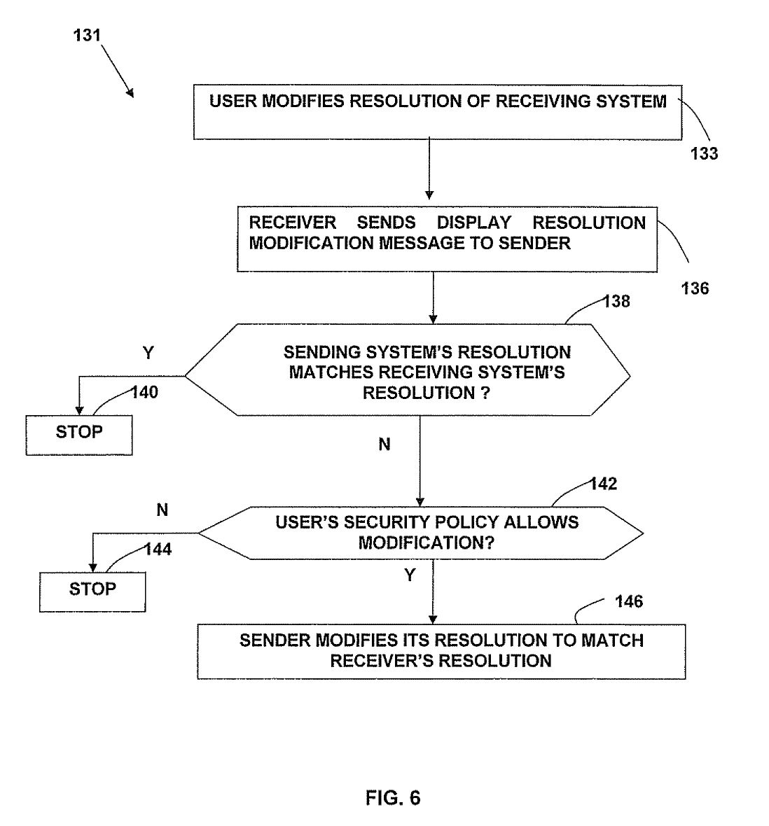

In the embodiment of FIG. 6, the process of modifying the sending system's resolution begins with the receiving system 30 connecting to the sending system 12. During operation of the system 10, a user of the receiving system 30 may modify the display resolution of the receiving system 30 at which point the receiving system's resolution would not necessarily match the sending system's resolution. FIG. 6 provides a process 131 to address a resolution mismatch caused by a change to the receiving system's resolution when the user has configured system 10 to have the sending system 12 modify its display resolution to match that of the receiving system 30. Referring to FIG. 6, the process 131 begins with a user modifying the resolution of the receiving system 30 (block 133). At 136, the receiver 36 sends a display resolution modification message to the sender 22. From that point, the embodiment of FIG. 6 is the same as, or at least similar to, the embodiment of FIG. 5. User authentication previously occurred (when, for example, the receiving system 30 initially connected to the sending system 12) and thus can be, but need not be, repeated in the embodiment of FIG. 6.

In accordance with another embodiment, the display resolutions of both the sending system 12 and receiving system 30 are modified, to the extent the resolutions are different, to a different resolution altogether. An example of when doing this may be desirable is when the receiving system 30 connects to the sending system 12 over a relatively low bandwidth link (network 25) relative to the display resolution currently set for the systems 12, 30. In this situation, it may be desirable to modify the resolutions of systems 12, 30 to a lower resolution setting more appropriate for the bandwidth of the network 25.

Some embodiments pertain to scaling the images themselves (also referred to as “re-sampling”) to account for a disparity in the resolution of the sending and receiving systems. In these embodiments, scaling the image refers to modifying information contained in the images to be replicated on the receiving system 30 so as to result in the resulting images being of a different resolution. Referring to FIG. 71 in one such embodiment of a method 150, the receiver 36 receives, such as upon the receiver's request, the sending system's resolution (block 152). At 154, the receiver 36 computes one or more scale factors to be used to scale the sending system's images to match the receiving system's display resolution or display window size.

Scale factors are computed in some illustrative embodiments by calculating the ratio of the receiver's display width to the sender's display width as well as the receiver's display height to the sender's display height. The width and height are measured in terms of numbers of pixels. Based on these ratios, image scaling algorithms can be applied to scale the images up or down. The receiver 36 receives images from the sender 12. The receiver keeps a representation of the sender's desktop in the memory of the receiver system. If the scaling is being applied by the receiver 30, when the receiver displays the desktop of the remote computer, the image is scaled up or down appropriately to match either the resolution of the receiver system 30 or the window that is used to display the desktop of the remote sending system 12. If the sender scales the image, then the receiver 30 decompresses the image that is sent by the sender 12, and then scales the image before placing the image into a frame buffer in the receiving system.

At 156, the receiver 36 receives images from the sender 22 and scales the received images according to the scale factors. Either or both of actions 154 and 156 are performed by the sender's RDRSAC 44 in at least some embodiments.

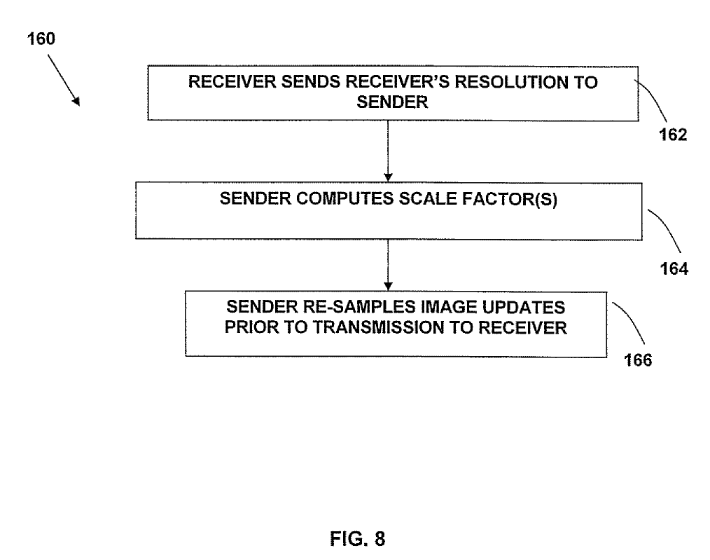

FIG. 8 shows a method 160 by which the sender 22 scales the images prior to transmission of the images to the receiver 36. At 162, upon the receiving system's initial connection to the sending system 12 or upon a modification to the receiving system's resolution, the receiver 36 sends its resolution to the sender 22. The sender computes (block 164) one or more scale factors to map the images generated by the sending system 12 to comport with the receiving system's resolution. At 166, the sender 22 uses the scaled factors to re-sample its images prior to transmitting the images to the receiver 36. Either or both of actions 164 and 166 are performed by the sender's SDRSAC 54 in at least some embodiments.

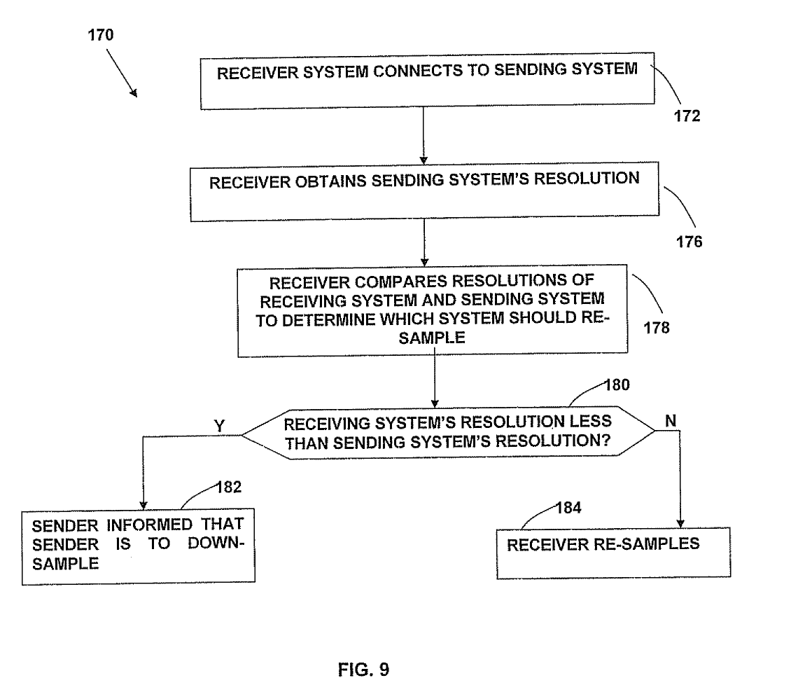

FIG. 9 illustrates an “auto-scale” method 170 in which, depending on the resolution of the sending system 12 compared to that of the receiving system 30, either the sender 22 or the receiver 36 scales the images. At 172, the receiving system 30 connects to the sending system 12. At 176, the receiver 36 obtains the sending system's resolution. Further, at 178, the receiver 36 compares the resolution of the sending system 12 to the resolution of the receiving system 30 to determine (block 180) which system (the sending system 12 or the receiving system 30) should scale the images. If the receiving system's resolution is less than the sending system's resolution, then, at 182, the sender 22 is informed by the receiver 36 that the sender is to scale its images before sending the images to the receiver. In at least one embodiment, the sender 22 computes an appropriate scale factor and down-samples the images to comport with the receiving system's resolution. On the other hand, if the receiving system's resolution is greater than the sending system's resolution, then, at 184, the receiver 36 computes an appropriate scale factor and scales the images received from the sender 22.

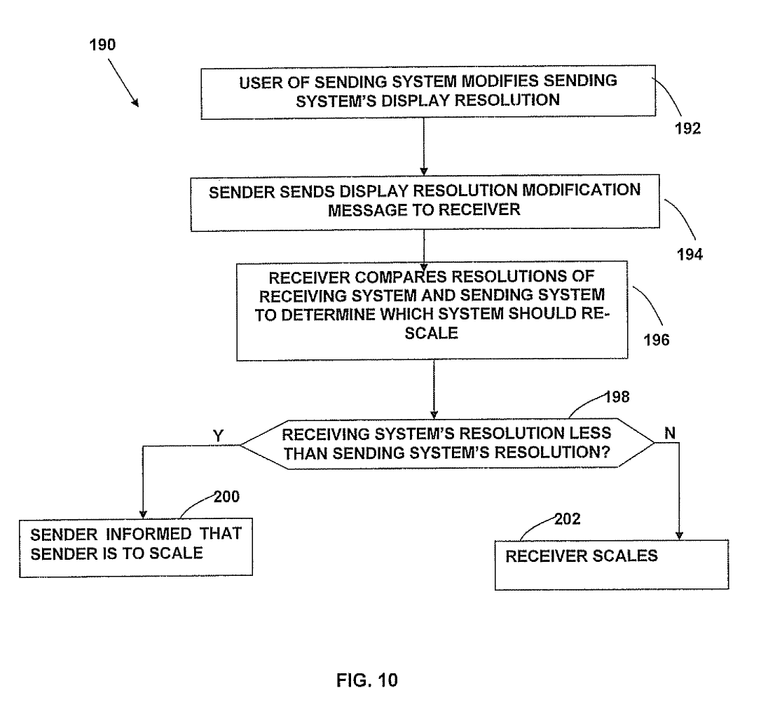

FIG. 10 illustrates a method 190 by which the display resolution of the sending system is modified and the user has selected the auto-scale function. At 192, the user of the sending system modifies the sending system's display resolution. The sender's SDRMC 58 is invoked. The SDRMC 58 makes the requested resolution modification and, at 194, sends a display resolution modification message to the receiver 36 to inform the receiver of the sending system's newly set display resolution. At 196, the receiver 36 compares the resolution of the sending system 12 to the resolution of the receiving system 30 to determine (block 198) which system (the sending system 12 or the receiving system 30) should scale the images. If the receiving system's resolution is less than the sending system's resolution, then, at 200, the sender 22 is informed by the receiver 36 that the sender is to compute an appropriate scale factor and scale its images before sending the images to the receiver. Specifically, the sender 22 down-samples the images to comport with the receiving system's resolution. On the other hand, if the receiving system's resolution is greater than the sending system's resolution, then, at 202, the receiver 36 computes an appropriate scale factor and scales the images received from the sender 22.

In some embodiments, images are scaled based on the display resolutions of the sending and receiving systems 12, 30. In other embodiments, image scaling is based on a comparison of the size of the remote display windows of the sending and receiving systems. A remote display window is a window that is displayed on one system (remote or sender) that contains the desktop of the other system. In some embodiments, both image scaling and resolution adjustment is performed. For example, either of systems 12, 30 may perform image scaling as described above at one point in time, but the system 10 may switch to resolution adjustment at a later point in time.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method, comprising:
receiving, by a first system, from a second system a display resolution of the second system, the first and second systems being remotely coupled to one another via a network; and
either setting, by the first system, the display resolution of the first system to match the received display resolution of the second system or scaling, by the first system, an image to account for any difference between the display resolutions or display window sizes of the first and second systems.

2. The method of claim 1 further comprising determining, by the first system, whether the display resolution of the first system matches the received display resolution from the second system.

3. The method of claim 1 wherein receiving, by the first system, the second system's display resolution comprises receiving the second system's display resolution upon the first and second system coupling.

4. The method of claim 1 further comprising adjusting the second system's display resolution.

5. The method of claim 4 wherein adjusting the second system's display resolution causes the first system to receive the second system's display resolution.

6. The method of claim 1 further comprising authenticating a user.

7. The method of claim 1 wherein setting, by the first system, the display resolution of the first system to match the received display resolution of the second system occurs upon successful authentication of the user.

8. The method of claim 1 wherein setting, by the first system, the display resolution of the first system to match the received display resolution of the second system occurs if a security policy associated with a user of the first system permits changes to the first system's display resolution.

9. The method of claim 8 further comprising precluding the first system from setting the display resolution of the first system to match the received display resolution of the second system if the security policy does not permit changes to the first system's display resolution.

10. The method of claim 8 further comprising causing the causing second system to set the display resolution of the second system to match the display resolution of the first system if the security policy does not permit changes to the first system's display resolution.

11. The method of claim 1 wherein scaling the image comprises computing a scale factor based on the display resolutions or display window sizes of the first and second systems.

12. A local system, comprising:
a graphics subsystem configurable to any of a plurality of display resolutions;
logic operatively coupled to said graphics subsystem, said logic obtains a display resolution from a remote system via a network and said logic either sets the display resolution of said graphics subsystem to match said remote system's display resolution or scales an image to account for a difference between the display resolutions or display window sizes of the local and remote systems.

13. The system of claim 12 wherein said logic determines whether a display resolution of the graphics subsystem matches the display resolution obtained from the remote system.

14. The system of claim 12 further comprising a user authentication device usable to authenticate a user.

15. The system of claim 12 wherein the logic sets the display resolution of the graphics subsystem to match the display resolution obtained from the remote system upon successful authentication of a user.

16. The system of claim 12 wherein the logic sets the display resolution of the graphics subsystem to match the display resolution obtained from the remote system if a security policy permits changes to the graphics subsystem's display resolution.

17. The system of claim 16 wherein said logic precludes the graphics subsystem's display resolution from being changed if the security policy does not permit changes to the graphics subsystem's display resolution.

18. The system of claim 12 wherein said logic scales the image by computing a scale factor based on the display resolutions or display window sizes of the local and remote systems.

19. A system, comprising:
a first system comprising a programmable display resolution;
a second system coupleable with said first system via a network, said second system transmits to the first system a display resolution configured for the second system;
wherein said first system either sets a display resolution of the first system to match the received display resolution of the second system or scales an image to account for any difference between the display resolutions or display window sizes of the first and second systems.

20. The system of claim 19 wherein the first system determines whether the display resolution of the first system matches the received display resolution from the second system.

21. The system of claim 19 wherein the first system sets the display resolution of the first system or scales the image upon successful authentication of a user.

22. The system of claim 19 wherein the first system scales the image comprises by computing a scale factor based on the display resolutions or display window sizes of the first and second systems.
